(19) United States
(12) Patent Application Publication
(10) Pub. No.: US 2024/0143774 A1
(43) Pub. Date: May 2, 2024

(54) ATTRIBUTE BASED DATA ACCESS CONTROL

(71) Applicant: Baker Hughes Holdings LLC, Houston, TX (US)

(72) Inventor: Sebastian E. Ramirez-Cunarro, Houston, TX (US)

(21) Appl. No.: 17/973,859

(22) Filed: Oct. 26, 2022

(51) Int. Cl. G06F 21/57

(52) U.S. Cl. CPC G06F 21/577; G06F 2221/034

(57) ABSTRACT

Methods, systems, and computer-readable storage media for compliant access to data from a database using an attribute based access control. A method may include receiving a query requiring an access to data. The data is classified to determine restrictions based on a level of risk related to the access to the data. Data access constraints are determined based on the restrictions of the data. Data access clearance is generated based on the data access constraints. A data access control result is provided based on the data access clearance.

### TECHNICAL FIELD

The subject matter disclosed herein relates to systems and methods for controlling data access. More specifically, the subject matter disclosed herein relates to compliant access to data from a database using an attribute based access control.

### BACKGROUND

Data associated with an industrial operation can provide useful insight into the industrial operation. For example, industrial data can be used to develop data models and can be used as input for algorithms that allow for improvement of industrial processes (e.g., by predicting desirable operating parameters associated with the industrial operation). Industrial data of multiple owners can be stored in a common database. However, access to industrial data by a competitor can raise several issues. It is recognized that improved systems and methods for controlling data access, based on increased security would be beneficial.

### SUMMARY

Some implementations commensurate in scope with the originally claimed invention are summarized below. These embodiments are not intended to limit the scope of the claimed invention, but rather these embodiments are intended only to provide a brief summary of possible forms of the invention. Indeed, the invention can encompass a variety of forms that can be similar to or different from the embodiments set forth below. In an embodiment, a system can include at least one processor, and at least one memory including a computer executable instructions, which when executed by the at least one processor causes performance of multiple operations. The operations include receiving a query requiring an access to data. The data can be classified to determine restrictions based on a level of risk related to the access to the data. Data access constraints are determined based on the restrictions of the data. Data access clearance can be generated based on the data access constraints. A data access control result can be provided based on the data access clearance.

In some variations, one or more features disclosed herein including the following features can optionally be included in any feasible combination. The level of risk can indicate a potential risk data access poses to the entity indicate by data or data publisher or data owner. The data can include object restriction as a limitation placed on a data object that defines conditions of the access. The data can be recorded by a sensor associated to a component of an industrial environment. The component can include a machine, a motor, a gas turbine, a heat exchanger, a centrifugal pump, a centrifugal compressor, a fan, a reciprocating compressor, a generator, a steam turbine, a wind turbine, piping, or any combination thereof. The sensor can include temperature sensors, current sensors, voltage sensors, pressure sensors, displacement sensors, velocity sensors, acceleration sensors, flow sensors, or any combination thereof. The operations can further include: applying the restrictions to the data based on data access level and access limitations. The data access clearance can be generated using an attribute based access control, an access-control list, or a role-based access control.

In another embodiment a non-transitory computer-readable medium includes machine-readable instructions executable by a processor, wherein the machine-readable instructions are configured to cause the processor to perform operations. The operations include receiving a query requiring an access to data. The data can be classified to determine restrictions based on a level of risk related to the access to the data. Data access constraints are determined based on the restrictions of the data. Data access clearance can be generated based on the data access constraints. A data access control result can be provided based on the data access clearance.

In another embodiment a method may include receiving a query requiring an access to data. The data can be classified to determine restrictions based on a level of risk related to the access to the data. Data access constraints are determined based on the restrictions of the data. Data access clearance can be generated based on the data access constraints. A data access control result can be provided based on the data access clearance.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an example of a block diagram of a data access system, in accordance with embodiments presented herein;

FIG. 2 illustrates a flow chart of a method for data access control, in accordance with embodiments presented herein; and

FIG. 3 illustrates a schematic view of an example of a data access control system, in accordance with embodiments presented herein.

### DETAILED DESCRIPTION

Improvements in rule based data access can allow for secure access to industrial operational data (e.g., operational data of oil pumps in an oil rig). In an industrial environment, operational data can be associated to a number of machines that can be operating together to perform various tasks related to production, processing, and transmission of item, such as oil, gas, or other chemicals. Generally, each of the machines in the industrial environment can include a number of sensors attached thereto to monitor various conditions within a respective machine reflective of a process condition. The industrial operational data received from systems of multiple (publishing) parties can be stored in a common database. The industrial operational data can refer to an entity, can be used by many collaborating parties, including the data publisher and one or more data consumers. For example, operational data can provide useful insight into industrial operations that can lead to improvement (e.g., optimization) of respective operations, which can be useful for the data publishers, and planning of associated operations, which can be useful for collaborating parties.

It can be challenging to facilitate a secured data exchange between a data consumer and a data publisher that allows the data consumer to have desirable control over the shared data and/or allows the data consumer to access meta-data associated with data of the data publisher. The current subject matter can provide for an improved data access, using an exchange system that can act as a repository, the exchange system allowing for secured and controlled exchange of data between the data publisher and the data consumer. The account type (defined by the account identifier) can define a confidentiality level in accessing the object. For example, a security posturing process and engine allows for compliant access to data (e.g., upstream oilfield data and gas data) taking into account data ownership, subject of the data ownership, contractual obligations, system security, usage constraints, and residency constraints. Compliant access to data enables secure data sharing, while previous systems were unable to utilize data collected from or about different parties operations and assets and compliantly share the operational data amongst different collaborating parties and systems.

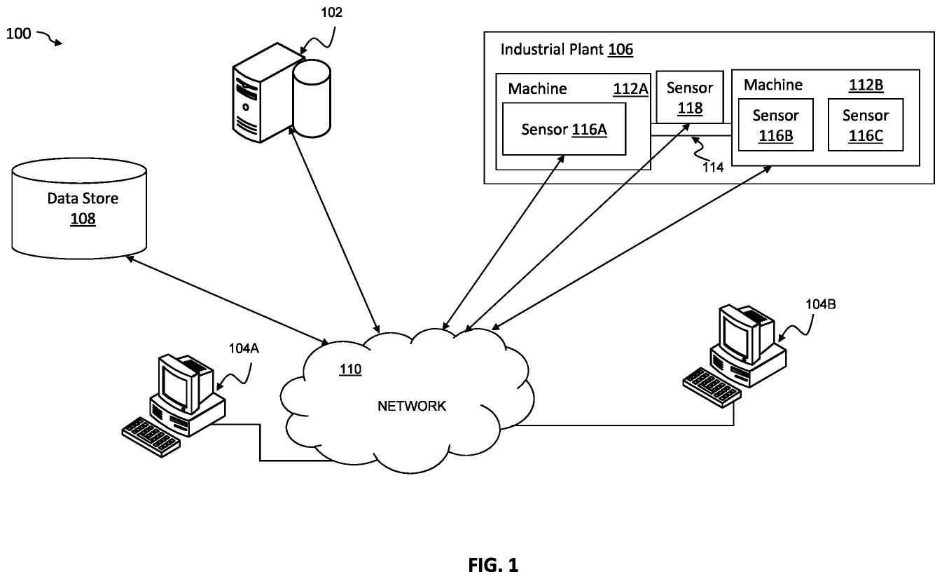

In some implementations, the compliant data access includes enabling or blocking access to data based on data attributes (restriction, geopolitical, usage, contract, subject/customer, owner, residency, export, classification) and clearance attributes (geopolitical, ownership, customer/subject, classification) in combination with the defined rules for execution to determine access to data and handling of data at a record level. A computing system can identify the constraints of an individual record or field of data to enable compliant access and usage of data based on an attribute access control. For example, the computing system can only allow access to data to the systems that have been granted permissions for such use. The computing system can provide forensic evidence of how the data was accessed on each individual record for each user device that requested access. Additional details with regard to how compliant access to data is regulated by a computing system based on an attribute based access control will be described below with reference to FIGS. 1-3.

By way of introduction, FIG. 1 illustrates a block diagram of an example of system 100 used for attribute based data access control. The example system 100 can include a data access control system 102, which can receive requests from multiple user devices 104A, 104B, to access data generated by components of an industrial plant 106 and stored in a data store 108. The components of the example system 100 can communicate with each other over a network 110. For example, the requests for data access can be transmitted by the user devices 104A, 104B to the data access control system 102 over a network 110. The data access control system 102 can include a server device intended to represent various forms of servers including, but not limited to a web server, an application server, a proxy server, a network server, and/or a server pool. In general, data access control system 102 accepts requests for access to data and controls a secure access to data for any number of user devices (e.g., the user devices 104A, 104B) over the network 110.

In some examples, the user devices 104A, 104B can communicate with each other and with the data access control system 102 over the network 110. In some examples, the user devices 104A, 104B can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some examples, the user devices 104A, 104B can include a data publisher device that owns the data generated by the industrial plant 106 and a collaborating device that is allowed access to the data generated by the industrial plant 106.

The data can be transmitted from the industrial plant 106 to the data store 108 over the network 110. The industrial plant 106 can include any type of industrial environment where different components or machines can be used to complete one or more industrial processes. As such, the industrial plant 106 can correspond to an oil refinery, a manufacturing facility, a turbomachine system, a power generation system, a gasification system, a chemical production system, a gas turbine system, a steam turbine system, a combined cycle system, a power plant, or the like. The components in the industrial plant 106 can include one or more machines 112A, 112B and one or more machine connectors 114. The machines 112A, 112B can include gas and oil well equipment, treatment units, electric motors, engines, turbines, pumps, compressors, and the like. The machine connectors 114 can be configured to connect two or more machines 112A, 112B within the same the industrial plant 106 or connected the industrial plants 106. Each machine 112A, 112B can include one or more sensors 116A, 116B, 116C and the machine connectors 114 can include one or more sensors 118.

The sensors 116A, 116B, 116C, 118 can monitor various aspects of an industrial process and/or of a respective machine 112A, 112B. The sensors 116A, 116B, 116C, 118 can include temperature sensors, current sensors, voltage sensors, pressure sensors, displacement sensors, vibration sensors, velocity sensors, acceleration sensors, flow sensors, clearance sensors, flame sensors, gas composition sensors, ultrasound sensors, clearance sensors, gas composition sensors, speed sensors, emissions sensors, radio frequency sensors, and any other type of sensor that can provide information with respect to an industrial process and/or the operation of a respective machine 112A, 112B or machine connector 114. Generally, the data acquired by the sensors 116A, 116B, 116C, 118 can be transmitted via the network 110 for storage in a data store 108. In some implementations, the data acquired by the sensors 116A, 116B, 116C, 118 can be processed by a processor of the industrial plant 106 before being transmitted via the network 110 for storage in the data store 108.

The network 110 can include a communication network with a direct link (i.e., hardwired), a network link, or a portable memory device (e.g., Universal Serial Bus memory drive). In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

The data store 108 stores information within the system 100, including industrial data received from sensors 116A, 116B, 116C, 118, from the industrial plant 106, from the user devices 104A, 104B and/or from the data access control system 102. The data store 108 can include a storage device that is capable of providing mass storage for the system 100. In one implementation, the data store 108 can include a computer-readable medium. In various different implementations, the data store 108 can include a floppy disk device, a hard disk device, an optical disk device, or a tape device.

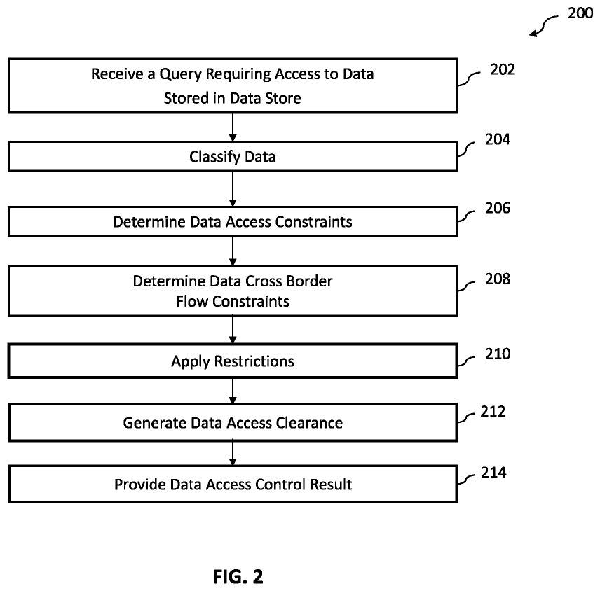

In some implementations, the data access control system 102 can ensure that data access within example system 100 (e.g., data store 108) complies with country and international laws, customer contractual requirements, and data publisher operating policies. The data access control system 102 can determine which user device 104A, 104B can have the clearance to access a particular data object, such as a data record, a document, or a report. For access control purposes, at their point of entry into the data store 108 of the example system 100, each and every data object, whether structured (e.g. data records) or unstructured (e.g. documents and reports), contains access control information. The access control information can be included in the associated metadata of the data for applications of the data access control system 102 whose role is to ascertain whether to grant or deny a given user device 104A, 104B access to the requested data to perform a task. The data access control system 102 can use different methods to manage the way in which user device 104A, 104B are matched to data, including data access control, such as attribute based access control (ABAC). ABAC differs from the other methods by defining that all the information required to grant or deny access is included directly on the data object requested by the user device 104A, 104B. ABAC can be implemented at a granular level (record by record, document by document). ABAC ensures that matching for each of the user device 104A, 104B with the permitted data objects can be performed at execution time, making it a flexible, reliable and maintainable method. Details of an example of a process executed by the data access control system 102 is described with reference to FIG. 2.

Although FIG. 1 has been described with respect to an industrial environment, it should be noted that the systems and techniques described herein can be applied to other systems outside of the industrial environment. As such, the systems and techniques described herein should not be limited to industrial environments and the like.

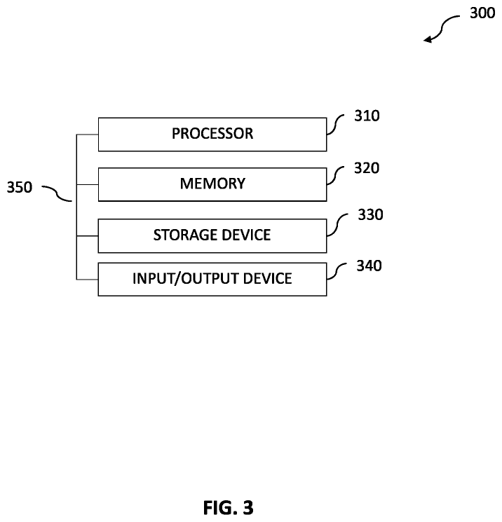

FIG. 2 illustrates an example of process 200 for providing data access control, according to some implementations of the current subject matter. The process 200 may be performed by one or more components of the systems shown in any of FIGS. 1 and 3, such as the data access control system 102 is described with reference to FIG. 1.

At 202, a query, including a request to access data stored within a data store is received. The data can include information in a digital form that was generated by sensors in an industrial plant that can be transmitted or processed. The data can include operational data (may be also referred to as “technical data”), which is that data corresponding to operational activities such as production, processing and/or manufacturing activities together with commercial, technical, and service operations related to supporting those activities. The data can include a data object. The data object can be formed by or containing data. The data can include documents having a data object with an unstructured format. The data can include records having a data object with a structured format. The data can include a field value. The field value can be the actual data in the field. In a data table an individual field can be thought of as the intersection between a specific field purpose (column) and a specific Data Record (row). It is analogous to a cell in a data table. The data can include a field purpose. The field purpose can define the kind of data a field in a document or record is to contain. A field purpose is not specific to any one document or data record, but rather to the format of the data object schema. Field purposes are necessary on a data object to provide information to users. It is analogous to a column in a data table. The data can include an attribute value, which is the actual data in the attribute. The attribute value can be included in a metadata of the data. The data can include an attribute purpose. The attribute purpose can define the kind of data an attribute of a document or record is to contain. An attribute purpose is not specific to any one document or data record, but rather to the format of the metadata around the document or record. The attribute purposes can be included in a data object to provide information to users and can be used by access rule implementations to enforce proper access control and usage. Every object can have attributes (field purposes) within its metadata that contain both the combination of classification and constraints that have been applied to the data object, and the values for them. Examples of data object attributes are illustrated by Tables 1 and 2.

TABLE 1

| Document and | |
|---|---|
| Record | |
| Attribute | |
| Purpose | Description |
| Restriction List | (ACL) List of user accounts that have access to the object. |
| Restriction | (RBAC) A special identifier per object or for a group of objects to |
| Object | be used to grant permissions to roles. |
| Restriction | (ABAC) Can always contain the access restriction sting for the data |
| Access | object (i.e. the data object's classification value + the constraint |
| | attribute combination that need to be accounted for by the matching |
| | policy rules when assessing a user right to access the data object |
| Restriction | (ABAC) Can always contain the three-letter ISO value representing |
| Geopolitical | the name of the country of origin of the subject matter contained in |
| | the data object |
| Restriction | (ABAC) Can always contain the ultimate Global Entity value (from |
| Subject terms | Customer MDM) of the company that is the owner of the subject |
| | matter contained in the data object. Often related to contracts. |
| Restriction | (ABAC) Can always contain the Owner of the data object, which |
| Owner terms | can be different from the contract terms of the data object. |
| Restriction Code | (ABAC) A special code used to limit access to named individuals if |
| word | the RestrictionAccess field contains “Codeword” |
| | e.g . . . a GUID or an employee ID for Sensitive Personally |
| | Identifiable Information (PII). |
| Restriction | (Required for Transmission Compliance) Object Cross-Border |
| Crossborder | Flow Restriction |
| flow | |
| Restriction | (Optional Knowledge) Contract related to the data object |
| Contractid | |
| Restriction | (Optional Knowledge) Object Usage Restriction |
| Usage | |
| Data Subject | (Optional Knowledge) Which organization owns the subject |
| | matter of the data object. |
| Data Owner | (Optional Knowledge) Which organization owns the data object. |

TABLE 2

| Field Attribute | |
|---|---|
| Purpose | Description |
| Restriction | (Option For ABAC) Should contain Object Classification |
| Classification | Restriction |

When handling data for a particular customer (collaborating user), there is often a need to limit access to those who work for that customer in a particular country. Sensitive data indicating where operations of an industrial plant were performed is one example. With ABAC, the data record/document can require the following attribute information to be considered when determining if the user should be allowed access to the object. “Does the user have a ‘confidential’ classification clearance entitlement AND ‘AcmeOil’ subject terms clearance entitlement? AND “QAT” geopolitical clearance? Examples of attributes used to determine if the user should be allowed access to the object are included in Table 3.

TABLE 3

| Object | | |
|---|---|---|
| Attribute | Values for data | |
| (ACL) | object (ACL) | |
| Restriction | Named list of user | |
| List | accounts or groups | |
| | that are granted | |
| | access based on | |
| | the other | |
| | attributes. | |
| Object | | |
| Attribute | Values for data | |
| (RBAC) | object (RBAC) | |
| Restriction | Role based on the | |
| Object | other attributes: | |
| | confidential- | |
| | subject terms of | |
| | entity at location 1 | |
| Object | | What is assessed to |
| Attribute | Values for data | determine User access to |
| (ABAC) | object (ABAC) | data object (ABAC) |
| Restriction | “confidential- | Do user's Classification clearances include |
| Access | subjectterms- | “confidential”? |
| | geopolitical” | |
| Restriction | QAT | Do user's geopolitical clearances include “QAT”? |
| Geopolitical | | |
| Restriction | Collaborating User | Do user's subjectterms clearances include “entity |
| Subjectterms | | at location 1”? |
| Restriction | Data Publisher | N/A |
| Ownerterms | | |
| Restriction | N/A | |
| Codeword | | |
| Restriction | N/A | |
| Crossborder | | |
| flow | | |

In some countries (in the example illustrated in Table 4, in Malaysia) and with some contracts, it is required to not only limit the data to people who work for the customer have geopolitical clearance for that country, but also to limit the data flow (e.g., place restrictions on the data leaving the country and whether users who are located outside of the country can access the data at all, and if so to what extent).

With ABAC, the data record/document/report would require the following attribute information to be considered when determining if a user should be allowed access to the object. “Does the user have a ‘confidential’ classification clearance entitlement AND do the user's geopolitical clearances include “MYS” AND do the user's subject terms clearances include ‘name of collaborating user’ AND is the user currently located within a preset location (e.g., Malaysia)?

TABLE 4

| Object Attribute | | |
|---|---|---|
| (ACL) | Values for data object (ACL) | |
| Restriction List | Named list of user accounts or | |
| | groups that are granted access | |
| | based on the other attributes. | |
| Object Attribute | Values for data object | |
| (RBAC) | (RBAC) | |
| Restriction Object | Role based on the other | |
| | attributes: confidential-subject | |
| | terms Name of collaborating | |
| | user -MYS | |
| | | What is assessed to determine |
| Object Attribute | Values for data object | User access to data object |
| (ABAC) | (ABAC) | (ABAC) |
| Restriction | “confidential-subjectterms- | Do user's Classification |
| Access | geopolitical” | clearances include “confidential”? |
| Restriction | MYS | Do user's geopolitical clearances |
| Geopolitical | | include “MYS” |
| Restriction | Name of collaborating user | Do user's subjectterms clearances |
| Subject terms | | include “Name of collaborating |
| | | user” |
| Restriction | Name of data publisher/owner/ | N/A |
| Owner terms | entity indicated by the data | |
| Restriction | — | |
| Codeword | | |
| Restriction | “localizationnoexport” | Is the user accessing the data |
| Crossborder flow | | from within location 1 |
| | | (Malaysia)? |

Often when a record has been filed as “tight” with a governing authority, the company has been given exclusive rights to data around a well for a period of time as acknowledgement of the significant investment required to explore the underlying strata. This is a significant competitive advantage to the company concerned. In such instances only individuals named in a contract or who have signed a specific NDA are allowed access to the data. With ABAC, the data record/document would require the following attribute information to be considered when determining if the user should be allowed access to the object. “Does the user have a ‘confidential’ classification clearance entitlement AND do the user's code word clearances include the string “UMBRA,” as illustrated in Table 5.

TABLE 5

| Object | Values for | |
|---|---|---|
| Attribute | data object | |
| (ACL) | (ACL) | |
| RestrictionList | Named list of user | |
| | accounts or groups that | |
| | are granted access | |
| | based on the other | |
| | attributes. | |
| Object | Values for | |
| Attribute | data object | |
| (RBAC) | (RBAC) | |
| Restriction | Role based on the other | |
| Object | attributes: confidential- | |
| | codewordUMBRA | |
| Object | Values for | |
| Attribute | data object | What is assessed to determine User |
| (ABAC) | (ABAC) | access to data object (ABAC) |
| Restriction | “confidential- | Do user's Classification clearances |
| Access | codeword” | include “confidential”? |
| Restriction | MYS | N/A |
| Geopolitical | | |
| Restriction | Collaborating User | N/A |
| Subjectterms | | |
| Restriction | Data owner | N/A |
| Ownerterms | | |
| Restriction | “UMBRA” | Do user's Codeowrd clearances include |
| Codeword | | the string “UMBRA”? |
| Restriction | — | |
| Crossborder | | |
| flow | | |

The data can include object restriction as a limitation placed on a data object that defines some form of conditions on the access, use, processing, etc. of the data object. The data can include a classification, which is a restriction level placed on documents, records, and possibly field purposes that indicates the level of financial or reputational risk posed to an entity if the data were lost, stolen, compromised, or unavailable. By assigning a classification to data objects the data owners assist the data access control system select the level of system custodial capabilities and security needed to appropriately secure and support the data objects that are classified. The query can include a data identifier and a user identifier. The user identifier can identify a user device that originated the request, an identity of an entity owning the user device, and/or an identity of a user of the user device. In some implementations, the user identifier can indicate a relationship between a data owner or entity indicated by the data and the user (e.g., user identifier can indicate that the user is a subscriber, associate, or collaborating party). The query can be processed to determine the data stored in the data store, the data object, field values, field purposes, attribute values, attribute purposes, object restriction, and data classification.

At 204, data is classified to determine restrictions based on the level of risk related to the access. The level of risk indicates a potential risk data access poses to the entity indicate by data or data publisher or data owner. Access restriction for an object is the combination of the object's classification restriction and any constraint restrictions that are applied to the object. The restriction applies to human user accounts and system user accounts, either of which can have appropriate entitlement clearances for those restrictions to access the object of the requested data. Table 6 and Table 7 (for records/documents/reports and for field purposes) list examples of data classifications (in bold), and their alignment with an entity policy-level classification values. In Table 6 and Table 7, confidential elevated is a system classification for confidential data and is used to indicate that more stringent network, server, and monitoring is to be enabled for a stronger system security posturing but not data access control.

TABLE 6

| | | Confidentiality | |
|---|---|---|---|
| Entity Data | IT System | Data | |
| Classification | Classification | Classification | Risk & Restriction considerations |
| Public | Public | public | Data with low risk if improperly |
| | | | accessed. Anyone with access to |
| | | | the system hosting the data can |
| | | | access the data. User accounts may |
| | | | still be subject to standard system |
| | | | level access, password and other |
| | | | security requirements. |
| Confidential | Confidential, | confidential | Data with low to moderate risk if |
| | Confidential | | improperly accessed. Generally, |
| | Elevated* | | data that requires moderate access |
| | | | control. |
| | | confidential_sPII | Personal identifiable information |
| | | | data that is “sensitive” and has |
| | | | elevated risk if improperly |
| | | | accessed. Generally, data that |
| | | | requires named individual |
| | | | restriction (entitlement clearance), |
| | | | e.g. health records accessible only |
| | | | to people with a business “need to |
| | | | know”. |
| Highly | | Highly | Data that presents significant risk if |
| Confidential | | confidential | improperly accessed. Generally, |
| | | | data that requires special |
| | | | permissions for job purposes and |
| | | | limited to very few individuals. |
| | | | Generally, data that requires |
| | | | moderate to advanced access |
| | | | controls. |
| | | unknown | Data object with unknown risk if |
| | | | improperly accessed. Generally, |
| | | | data object that cannot be used until |
| | | | it is properly classified and as such |
| | | | is only visible to a System Admin. |

TABLE 7

| Data | IT System | Data | |
|---|---|---|---|
| Classification | Classification | Classification | Risk & Restriction considerations |
| Public | Public | public | As for Data Record/Document |
| | | | above |
| Confidential | Confidential, | confidential | As for Data Record/Document |
| | Confidential | | above |
| | Elevated* | confidential_nsPII | Personal identifiable information |
| | | | data that is “non-sensitive”. For |
| | | | example, a name or Work ID may |
| | | | be deemed non-sensitive if used in |
| | | | isolation. PII data included in |
| | | | systems must be appropriate to the |
| | | | context of the object in which it |
| | | | exists, and its existence must add |
| | | | true business value to the users of |
| | | | that object |
| | | confidential_sPII | As for Data Record/Document |
| | | | above |
| HighlyConfidential | | highlyconfidential | As for Data Record/Document |
| | | | above |
| | | unknown | As for Data Record/Document |
| | | | above |

Highly confidential data can be tightly controlled, and system accounts are generally not an approved to access highly confidential data. Sensitive Personally Identifiable Information (PII) data is tightly controlled data, and system accounts are generally not an approved to access highly confidential data. Data can include restriction variations that may be dependent on the associated operations (e.g., production phase of a well). While access restrictions can be recommended and pre-approved, there may be circumstances where for a particular data object the level of restriction needs to be changed from the recommended values. In such cases the proposed change might need to be authorized to comply with data access restriction identification.

At 206, data access constraints are determined based on the restrictions and based on additional factors such as those imposed by national law applicable to the data or by contractual obligations that could correspond to a collaborating party requesting data access. Data object constraints apply restrictions on who can access the data object. The constraints can be applicable to data objects, such as documents and records. The constraints are not applied to field purposes. The constraints can enable data objects to be designed to comply with potential obligation combinations that, together with classification, determine the set of clearance entitlements required by a user to access that data object. The obligation combinations can be formed, for example, to account for observing legal mandates, meeting customer contract wording and addressing geographical political sensitivity. Data objects can have constraint term values in place to be able to meet potential constraints that are applied to the object. Only the constraint values whose term is identified as relevant for that specific data object can be evaluated against a user's clearances. Constraints can include restrictions that may be placed on an object to identify requirements to comply with obligations covering national legal requirements, contractual terms and conditions (customer/supplier/standard contracts), requirements imposed on the data by the owner of the object, and a combinations thereof. Table 8 illustrates an example of constraint term and associated meaning.

TABLE 8

| Constraint | |
|---|---|
| term | When the value for a constraint term should be evaluated |
| <none> | N/A |
| geopolitical | if a user can hold a specific clearance for a country in order to have |
| | access to data whose origin lies within that country |
| Subject terms | if a user can hold a specific clearance indicating approval to access the |
| | data by the owner of the subject matter held within the data object. |
| | (e.g. a customer whose oilfield was the source of the data may have |
| | negotiated in the contract held with OFSD that only OFS personnel |
| | working on their projects should be able to view that data). |
| Owner terms | if a user can hold a specific clearance indicating approval to access the |
| | data by the owner of the data object |
| | (e.g. if the data is held on a Baker Hughes/OFSD system, Baker |
| | Hughes may specify that only people who are Baker Hughes |
| | employees and have that clearance should have access to that data, or |
| | that a specific permission to view it by others is “licensed” by Baker |
| | Hughes). |
| Subject terms | if access to the data object requires appropriate subjectterms OR |
| OR | geopolitical clearance |
| geopolitical | |
| clearance | if access to the data object requires appropriate ownerterms OR |
| | geopolitical restrictions |
| Subject OR | if access to the data object requires appropriate subjectterms OR |
| owner terms | ownerterms clearance |
| Subject OR | if access to the data object requires appropriate subjectterms OR |
| ownerterms | ownerterms OR geopolitical clearance |
| OR | |
| geopolitical | |
| subjectterms- | if access to the data object requires appropriate subjectterms AND |
| geopolitical | geopolitical clearances |
| ownerterms- | if access to the data object requires appropriate ownerterms AND |
| geopolitical | geopolitical clearances |
| Subject OR | if access to the data object requires (either appropriate subjectterms OR |
| ownerterms- | appropriate ownerterms clearance) AND appropriate geopolitical |
| geopolitical | clearance |
| codeword | In circumstances where a data object presents elevated risk if accessed |
| | without proper authorization. For example, in cases such as |
| | data objects for tight wells where access is limited to |
| | contractual named individuals |
| | Sensitive PII objects where access is limited to HR staff |
| | responsible for the employee |
| | the data object should only be accessed by named individuals, and a |
| | codeword clearance would be applied to those individuals only. |
| | The codeword restriction is normally applied to comply with the need |
| | for contracts or policies that contain “named individual” access |
| | obligations. The restriction and matching clearance values consist of a |
| | unique string. |

At 208, data cross border flow constraints are determined based on the set of restriction values that determine geographical boundary relationship restrictions that must be applied to location of the server (data store 108, described with reference to FIG. 1) containing the data concerned, the location of those wishing to access the data concerned, and limitations of cross border actions that can be performed on that data. The cross border flow constraints can include restrictions that may be placed on data records, and documents for specific data needs that comply with regulatory or contractual needs to specify limits on actions of users on data, for the users and user devices that are not located in the same country as the data store. The cross-border flow restriction places a limitation on the respective locations of the data and the users accessing that data, irrespective of whether the users have the correct access restrictions to that data (e.g., where the user is located when accessing the data can determine if they can access the data). During initial cost benefit analysis as part of system planning and justification, a key consideration can be whether a cross-border flow restriction is required. If cross-border flow restriction is required, providing data access can imply significant deployment and support costs. Restriction values define limitations on the geographical boundaries that dictate where the data can reside, the extent of operations that can be performed on that data and related stipulations, and whether anyone can access it if they are not themselves located within the same geographical boundaries that have been applied to the data. Examples of data cross border flow constraints are illustrated in Table 9.

TABLE 9

| Data Cross Border | |
|---|---|
| Flow | Description |
| None | No cross-border flow restrictions |
| Residency | The primary instance of the object can be kept within the |
| | borders of the country of the data record. Copies of, or access to, |
| | the data is allowed if the primary data stays within country. |
| | Requirements include but are not limited to: Data can be deleted |
| | from all other systems before being deleted from the primary |
| | location. |
| Sovereignty | The object is governed by the laws of the country of residence, |
| | and the primary instance of the object can be kept within the |
| | borders of the country of the object. Copies of, or access to, the |
| | data is allowed if the primary data stays within country. |
| | Requirements include but are not limited to: Data can be deleted |
| | from all other systems before being deleted from the primary |
| | location. |
| Localization | The object is governed by the laws of its country of residence |
| | and can be kept within the borders of that country. No copies of |
| | the object may be made, and access to the object is not permitted |
| | other than for transferring the object for viewing in a short-lived |
| | read-only capacity (no copying). |
| LocalizationNoExport | The object is governed by the laws of its country of residence |
| | and can be kept within the borders of that country. No viewing |
| | of object is allowed outside of the country. |

At 210, restrictions are applied to data objects according to corresponding real-world situations. In some implementations, the restrictions are applied using restriction strings. Data object access restrictions strings define the clearance entitlements a user can have before that user may access the data object. The access restriction string on a document or record is the combination of the data object's classification value plus any constraint restrictions that have been applied. The access to a field purpose can be based on the classification of the field purpose. Tables 10 and 11 list the possible access restrictions for documents/records and then field purposes, going from least to most stringent.

TABLE 10

| Document and Record Access | Access limited by |
|---|---|
| public | No limitation |
| public-geopolitical | Country |
| confidential | Object Classification |
| confidential-subject OR owner terms OR | Object Classification + (Subject T&Cs |
| geopolitical | or Owner T&Cs or Country) |
| confidential-subjecttermsORgeopolitical | Object Classification + (Subject T&Cs |
| | or Country) |
| confidential-ownertermsORgeopolitical | Object Classification + (Owner T&Cs or |
| | Country) |
| confidential-geopolitical | Object Classification + Country |
| confidential-subject OR owner terms | Object Classification + (Subject T&Cs |
| | or Owner T&Cs) |
| confidential-subjectterms | Object Classification + Subject T&Cs |
| confidential-ownerterms | Object Classification + Object |
| | Ownership |
| confidential-subject OR owner terms- | Object Classification + (Subject T&Cs |
| geopolitical | or Owner T&Cs) + Country |
| confidential-subjectterms-geopolitical | Object Classification + Subject T&Cs + |
| | Country |
| confidential-ownerterms-geopolitical | Object Classification + Owner T&Cs + |
| | Country |
| confidential-codeword | Object Classification + Code |
| confidential_sPII-codeword | Object Classification + Code |
| highlyconfidential | Object Classification |
| highlyconfidential-subject OR owner terms | Object Classification + (Subject T&Cs |
| OR geopolitical | or Owner T&Cs or Country) |
| highlyconfidential- | Object Classification + (Subject T&Cs |
| subjecttermsORgeopolitical | or Country) |
| highlyconfidential-ownertermsORgeopolitical | Object Classification + (Owner T&Cs or |
| | Country) |
| highlyconfidential-geopolitical | Object Classification + Country |
| highlyconfidential-subject OR owner terms | Object Classification + (Subject T&Cs |
| | or Owner T&Cs) |
| highlyconfidential-subjectterms | Object Classification + Subject T&Cs |
| highlyconfidential-ownerterms | Object Classification + Owner T&Cs |
| highlyconfidential-subject OR owner terms- | Object Classification + (Subject T&Cs |
| geopolitical | or Owner T&Cs) + Country |
| highlyconfidential-subjectterms-geopolitical | Object Classification + Subject T&Cs + |
| | Country |
| highlyconfidential-ownerterms-geopolitical | Object Classification + Owner T&Cs + |
| | Country |
| highlyconfidential-codeword | Object Classification + Code |
| unknown | Only System Admin may access |

TABLE 11

| Field Purpose Access | Access limited by |
|---|---|
| public | No limitation |
| confidential | Object Classification |
| confidential_nsPII | Object Classification |
| confidential_sPII | Object Classification |
| highlyconfidential | Object Classification |
| unknown | Only System Admin may access |

At 212, data access clearance is generated using user clearance entitlements that can be transmitted to user accounts to access data. The user clearance entitlements include descriptions of the approaches that can be used to match user account identifiers (both human and system) to data based on clearance entitlements given to the user accounts requesting access to data. The approaches can include attribute based access control (ABAC), access-control list (ACL), role-based access control (RBAC) or other methods.

In some implementations, an approach to data access control and sharing between systems is to match “Restrictions” assigned to individual data objects such as records or reports, with “Clearances” (Entitlements) assigned to User and System Accounts, using a matching method called ABAC. In ABAC, only user accounts, which have equivalent clearance entitlements for the restriction values applied to a data object can access the requested data object. The data itself contains the information that defines who can access it. Using ABAC, data object restrictions may be applied at a granular level, yet the isolation between the restrictions applied on the data objects, and the clearance entitlements applied on accounts wishing to access those objects, make the ABAC approach flexible, reliable and maintainable. While both of the other methodologies mentioned (ACL and RBAC) can be used to achieve a similar result, ACL and RBAC can be less flexible than ABAC.

For example, ACL includes a list of permissions associated with a system resource (object). ACL specifies which user accounts and system accounts are granted access to objects, as well as what operations are allowed on given objects. Each entry in a typical ACL specifies a subject and an operation. In ACL each object can contain a list indicating the Accounts/Groups etc. that have access to that object, and the permitted operations for each account/groups on that object. This list can be defined as part of the object itself or can be held in an external system (such as active directory) such that the code executing on the object can query for permissions based on a lookup key/object identifier that is contained in the object. For this methodology, we are managing the Access operation on a particular object with no more granularity. In ACL, the onus of making sure the user accounts and system accounts assigned lists have appropriate clearance entitlements for the object is based on the person establishing the ACL's interpretation of the needs for objects that exist or will be produced. There is no enforcement of policy based on information contained within attributes of the data objects themselves; only on the understanding when the access is granted or revoked. Any change to the data object that may change the understanding of what operations accounts/groups can be allowed to execute, requires an update to the ACL lists on the objects not just to the account or role itself. The correctness of permissions for each account/group for different objects can be rigorously controlled, as the determination of whether an operation can be executed by a given account/group is done at the initial time when all permissions for that account/group are granted, not at operation execution time (run-time).

RBAC or role-based security is an approach to restricting system access to authorized users. It is an approach to implement mandatory access control (MAC) or discretionary access control (DAC). RBAC is a policy-neutral access-control mechanism defined around roles and privileges. The components of RBAC such as role-permissions, user-role and role-role relationships make it simple to perform user assignments. In RBAC, Accounts are assigned roles, those roles are assigned permissions, and those permissions are created as a combination of operation and object. In RBAC, the Access operation on a particular object is managed at the object level, with no additional granularity. As in ACL, in RBAC the onus of making sure the Accounts assigned roles are cleared for the object, is based on interpretation of the needs for objects that exist or will be produced by the person establishing the roles and their capabilities at the time of creating those capabilities. There is no enforcement of policy based on information contained within attributes of the data objects themselves; only on the understanding when the access is granted or revoked. Further, any change to the object itself that changes the understanding of what operations particular Roles would be allowed to perform (i.e. object attributes) would likely require changes to Roles and potentially re-assignment of roles to accounts. The correctness of the permissions allocated to each role for different objects can be rigorously controlled, as the determination of whether an operation can be executed by a given role is done at the time when permissions for that role are determined/granted, and not at operation execution time (run-time). Common use cases of RBAC include systems where permissions are determined by roles and not operations. For example, a salesman vs. an operator vs. a customer etc. Other use cases of RBAC include systems that need to control actions on an engagement basis (e.g., a workflow or a job operation like managing a construction operation on one well vs another well where the permissions need to be different across wells based on the role). RBAC can be common in real time control systems. An account role can be created for each restriction object combination. Account roles can be mapped to organizational roles, entitlement roles, or a combination thereof e.g., Administrator, application-engineer, reader, application-engineer-administrator. A restriction object could be to the level of a record or document or could be the nexus object for a group of objects like a well or a job/sales order.

ABAC, also known as policy-based access control (PBAC) for Identity Management, defines an access control paradigm whereby access rights are evaluated for user accounts and system accounts through policies which combine attributes together. The policies can use any type of attributes (user attributes, resource attributes, object, environment attributes etc.). This model supports Boolean logic, in which rules contain “IF, THEN” statements about who is making the request, the resource, and the action. In ABAC, objects are assigned restriction attributes, accounts are assigned clearance entitlement attributes, and policy rules are created to determine if a particular account has clearance to perform an operation on an object by validating the respective clearance entitlements and restriction attributes. The Access operation can be managed for a particular object with no more granularity. In ABAC the onus of making sure the user accounts and system accounts assigned roles are cleared for the object is based on the attributes of the object and attributes of the accounts, as policy is enforced at operation execution time. Further, if the attributes of an object change the access will change as it is evaluated as operations are executed. This is very scalable and adaptable based on the object itself. However, the need to check rules when performing an operation is less performant than granting permissions based on evaluating access ahead of time; thus it is common to implement the policy rules in a cache mechanism on any particular system and either push the policy rules from a central location or assure that the rules are local and compliant with policies. However, note that if multiple data objects are to have their classification changed, each and every object will have to have its attributes updated rather than just change central clearance entitlement. RBAC is a specialization of ABAC. ABAC can be used to have the granular control of RBAC related to roles with defined role attributes. This is common and is often used to distinguish between data operations and control operations. Common use cases of ABAC include systems where access to controls or data need to be broad in nature like data systems and aligned to a granularity of the data or objective rather than the transaction. Systems that require variable (changing) access to operations needs based on changes to policies or rules or attributes on the system or data and are not rigid at the time of initial access can also use ABAC. Systems, for which role control and clearance entitlement control are both necessary can also use ABAC. In ABAC, a user account whose set of clearance entitlements includes clearance entitlements matching the access restrictions applied to a data object may minimally view (read) the requested data object. Examples of access clearance entitlements that can be required to be compliant with data publisher classification and constraint obligations are included in Table 12.

TABLE 12

| Entitlement | Description |
|---|---|
| clearance-confidential | 0 . . . 1 entitlements - |
| | formatted as “clearance-confidential” |
| clearance- | 0 . . . 1 entitlements - |
| confidential_sPII | formatted as “clearance-sensitivePII” |
| clearance- | 0 . . . 1 entitlements - |
| highlyconfidential | formatted as “clearance-highlyconfidential” |
| clearance-geopolitical | 0 . . . N entitlements - |
| | formatted as “clearance-geopolitical-<ISO 3166 three- |
| | letter code>” |
| | where each clearance represents a single country |
| | e.g. “clearance-geopolitical-USA” |
| clearance-subjectterms | 0 . . . N entitlements - |
| | formatted as “clearance-subjectterms-<Baker Global |
| | Ultimate Account Name>” |
| | where each clearance represents a subject of contracts |
| | e.g. “clearance-subjectterms-Shell” |
| clearance-ownerterms | 0 . . . N entitlements - |
| | formatted as “clearance-ownerterms-<Baker Global |
| | Ultimate Account Name>” |
| | where each clearance represents a single owner |
| | e.g. “clearance-owner-BakerHughes” |
| clearance-codeword | 0 . . . N entitlements - |
| | formatted as “clearance-codeword-<unique ID like a |
| | GUID>” |
| | where each clearance represents a single code word |
| | e.g. “clearance-codeword-ee6718c6-3fad-495b-aadf- |
| | d938479b2cf0” |

Access policies can associate data object access restriction to required clearance entitlements for user to access that data object. The access policies can be required to be compliant with classification obligations and constraint obligations. Examples of are included in Table 13.

TABLE 13

| | Required Clearance Entitlements for User to |
|---|---|
| Data Object Access Restriction | access that Data Object |
| public | None required |
| public-geopolitical | clearance-geopolitical |
| confidential | clearance-confidential |
| confidential-subject OR ownerterms | clearance-confidential & (clearance-subjectterms |
| OR geopolitical | OR clearance-ownerterms OR clearance- |
| | geopolitical) |
| confidential-subjectterms OR | clearance-confidential & (clearance-subjectterms |
| geopolitical | OR clearance-geopolitical) |
| confidential-ownerterms OR | clearance-confidential & (clearance-ownerterms |
| geopolitical | OR clearance-geopolitical) |
| confidential-geopolitical | clearance-confidential & clearance-geopolitical |
| confidential-subject OR ownerterms | clearance-confidential & (clearance- subjectterms |
| | OR clearance-ownerterms) |
| confidential-subjectterms | clearance-confidential & clearance-subjectterms |
| confidential-ownerterms | clearance-confidential & clearance-ownerterms |
| confidential-subject OR owner | clearance-confidential & (clearance-subjectterms |
| terms-geopolitical | OR clearance- ownerterms) & clearance- |
| | geopolitical |
| confidential-subjectterms- | clearance-confidential & clearance-subjectterms |
| geopolitical | & clearance-geopolitical |
| confidential-ownerterms-geopolitical | clearance-confidential & clearance- ownerterms |
| | & clearance-geopolitical |
| confidential-codeword | clearance-confidential & clearance-codeword |
| confidential_sPII-codeword | clearance- confidential_sPII & clearance- |
| | codeword |
| highlyconfidential | clearance-highlyconfidential |
| highlyconfidential-subject OR owner | clearance- highlyconfidential & (clearance- |
| terms OR geopolitical | subjectterms OR clearance-ownerterms OR |
| | clearance-geopolitical) |
| highlyconfidential-subjectterms OR | clearance- highlyconfidential & (clearance- |
| geopolitical | subjectterms OR clearance-geopolitical) |
| highlyconfidential- | clearance- highlyconfidential & (clearance- |
| ownertermsORgeopolitical | ownerterms OR clearance-geopolitical) |
| highlyconfidential-geopolitical | clearance-highlyconfidential & clearance- |
| | geopolitical |
| highlyconfidential-subject OR | clearance-highlyconfidential & (clearance- |
| ownerterms | subjectterms OR clearance-ownerterms) |
| highlyconfidential-subjectterms | clearance-highlyconfidential & clearance- |
| | subjectterms |
| highlyconfidential-ownerterms | clearance-highlyconfidential & clearance- |
| | ownerterms |
| highlyconfidential-subject OR owner | clearance-highlyconfidential & (clearance- |
| terms-geopolitical | subjectterms OR clearance- ownerterms) & |
| | clearance-geopolitical |
| highlyconfidential-subjectterms- | clearance-highlyconfidential & clearance- |
| geopolitical | subjectterms & clearance-geopolitical |
| highlyconfidential-ownerterms- | clearance-highlyconfidential & clearance- |
| geopolitical | ownerterms & clearance-geopolitical |
| highlyconfidential-codeword | clearance-highlyconfidential & clearance- |
| | codeword |

In some implementations, optional access policies can also be used, such as the examples included in Table 14.

TABLE 14

| Object Access Restriction | Required Entitlements to access Object |
|---|---|
| public | None required |
| confidential | clearance-confidential |
| confidential_nsPII | clearance-confidential_nsPII |
| confidential_sPII | clearance-confidential_sPII |
| highlyconfidential | clearance-highlyconfidential |

The default requirements to adhere to policy is that humans access a data object to view it. Any time a human views that data object, the human needs to be subject to access control. Systems can also be able to access restricted data objects for internal system use (no human viewing it) for training of analytics or as a basis of processing. There will be no human use of those objects, as they are only for code. To access an object in a compliant manner with the ABAC in place systems can access the object on behalf of humans. The accessed object can be a public level object (public, company-public) and can be enabled with the use of a system account. The calling system can have a limited audience to internal or external employees and guarantee their associated employment relationship. The system can access object on behalf of an algorithm, where no human ever sees the object accessed. An example of a system configured to access an object on behalf of an algorithm can be triggered to train an object-driven model. The system cannot use the accounts to provide object to humans, only to processing code. Providing object to humans or the derived work on the accessed object to humans would be a violation of policy unless approved controls and written authorization from CSRC and data governance is provided. No person can use the below accounts to look at the data or download it. No system can use accounts associated with system training to make data visible for a user (e.g., by blocking or preventing transmission of data to a user account or another system). A system configured to access an object on behalf of an algorithm can be configured to run in an automated system data usage mode, e.g. for training data, by automatically preventing access to the data for users.

At 214, the data access control result is provided. If it determined, using the selected approach, that access to data is granted, the user device is granted access to at least a portion (rows) of data. For example, if the data access clearance indicates that the user device requesting data access has the right to read and/or edit data of a given data type, corresponding to a geopolitical region, with a particular subject (about an entity), generated by a particular entity (name of data owner), at a given location, with a particular classification, the user device is granted access to the data. If it determined, using the selected approach, that access to data is denied, an alert is generated to be displayed that access was denied.

In some implementations, the current subject matter (e.g., process described with reference to FIG. 2) may be configured to be implemented in a system 300, as shown in FIG. 3. The system 300 may include a processor 310, a memory 320, a storage device 330, and an input/output device 340. Each of the components 310, 320, 330 and 340 may be interconnected using a system bus 350. The processor 310 may be configured to process instructions for execution within the system 300. In some implementations, the processor 310 may be a single-threaded processor. In alternate implementations, the processor 310 may be a multi-threaded processor. The processor 310 may be further configured to process instructions stored in the memory 320 or on the storage device 330, including receiving or sending information through the input/output device 340. The processor 310 may be further configured to execute the processes described with reference to FIGS. 2 and 3. The memory 320 may store information within the system 300. In some implementations, the memory 320 may be a computer-readable medium. In alternate implementations, the memory 320 may be a volatile memory unit. In yet some implementations, the memory 320 may be a non-volatile memory unit. The storage device 330 may be capable of providing mass storage for the system 300. In some implementations, the storage device 330 may be a computer-readable medium. In alternate implementations, the storage device 330 may be a floppy disk device, a hard disk device, an optical disk device, a tape device, non-volatile solid state memory, or any other type of storage device. The input/output device 340 may be configured to provide input/output operations for the system 300. In some implementations, the input/output device 340 may include a keyboard and/or pointing device. In alternate implementations, the input/output device 340 may include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
at least one processor; and
at least one memory comprising a computer executable instructions, which when executed by the at least one processor causes operations comprising:
receiving a query requiring an access to data;
classifying the data to determine restrictions based on a level of risk related to the access to the data;
determining data access constraints based on the restrictions of the data;
generating data access clearance based on the data access constraints; and
providing a data access control result based on the data access clearance.

2. The system of claim 1, wherein the level of risk indicates a potential risk data access poses to the entity indicate by data or data publisher or data owner.

3. The system of claim 1, wherein the data comprises object restriction as a limitation placed on a data object that defines conditions of the access.

4. The system of claim 1, wherein the data is recorded by a sensor associated to a component of an industrial environment, wherein the sensor comprises temperature sensors, current sensors, voltage sensors, pressure sensors, displacement sensors, velocity sensors, acceleration sensors, flow sensors, or any combination thereof.

5. The system of claim 4, wherein the component comprises a machine, a motor, a gas turbine, a heat exchanger, a centrifugal pump, a centrifugal compressor, a fan, a reciprocating compressor, a generator, a steam turbine, a wind turbine, piping, or any combination thereof.

6. The system of claim 1, wherein the operations further comprise:
applying the restrictions to the data based on data access level and access limitations.

7. The system of claim 1, wherein the data access clearance is generated using an attribute based access control, an access-control list, or a role-based access control.

8. A non-transitory computer-readable medium comprising machine-readable instructions executable by a processor, wherein the machine-readable instructions are configured to cause the processor to perform operations comprising:
receiving a query requiring an access to data;
classifying the data to determine restrictions based on a level of risk related to the access to the data;
determining data access constraints based on the restrictions of the data;
generating data access clearance based on the data access constraints; and
providing a data access control result based on the data access clearance.

9. The non-transitory computer-readable medium of claim 8, wherein the level of risk indicates a potential risk data access poses to the entity indicate by data or data publisher or data owner.

10. The non-transitory computer-readable medium of claim 8, wherein the data comprises object restriction as a limitation placed on a data object that defines conditions of the access.

11. The non-transitory computer-readable medium of claim 8, wherein the data is recorded by a sensor associated to a component of an industrial environment.

12. The non-transitory computer-readable medium of claim 11, wherein the component comprises a machine, a motor, a gas turbine, a heat exchanger, a centrifugal pump, a centrifugal compressor, a fan, a reciprocating compressor, a generator, a steam turbine, a wind turbine, piping, or any combination thereof.

13. The non-transitory computer-readable medium of claim 11, wherein the sensor comprises temperature sensors, current sensors, voltage sensors, pressure sensors, displacement sensors, velocity sensors, acceleration sensors, flow sensors, or any combination thereof.

14. The non-transitory computer-readable medium of claim 8, wherein the operations further comprise:
applying the restrictions to the data based on data access level and access limitations, wherein the data access clearance is generated using an attribute based access control, an access-control list, or a role-based access control.

15. A computer implemented method comprising:
receiving a query requiring an access to data;
classifying the data to determine restrictions based on a level of risk related to the access to the data;
determining data access constraints based on the restrictions of the data;
generating data access clearance based on the data access constraints; and
providing a data access control result based on the data access clearance.

16. The computer implemented method of claim 15, wherein the level of risk indicates a potential risk data access poses to the entity indicate by data or data publisher or data owner.

17. The computer implemented method of claim 15, wherein the data comprises object restriction as a limitation placed on a data object that defines conditions of the access.

18. The computer implemented method of claim 15, wherein the data is recorded by a sensor associated to a component of an industrial environment.

19. The computer implemented method of claim 18, wherein the component comprises a machine, a motor, a gas turbine, a heat exchanger, a centrifugal pump, a centrifugal compressor, a fan, a reciprocating compressor, a generator, a steam turbine, a wind turbine, piping, or any combination thereof, and wherein the sensor comprises temperature sensors, current sensors, voltage sensors, pressure sensors, displacement sensors, velocity sensors, acceleration sensors, flow sensors, or any combination thereof.

20. The computer implemented method of claim 15, further comprising:
applying the restrictions to the data based on data access level and access limitations, wherein the data access clearance is generated using an attribute based access control, an access-control list, or a role-based access control.
